(19) United States
(12) Patent Application Publication
(10) Pub. No.: US 2010/0032488 A1
(43) Pub. Date: Feb. 11, 2010

(54) Mixing Valve Control System

(76) Inventor: Garry Edward Yates, Las Vegas, NV (US)

Correspondence Address: Garry E. Yates, 4085 Dustin Avenue, Las Vegas, NV, 89120, US

(21) Appl. No.: 12/186,516

(22) Filed: Aug. 6, 2008

(51) Int. Cl. G05D 23/13

(52) U.S. Cl. 236/12.1

(57) ABSTRACT

The mixing valve controller is a device that is used to control the position of a mixing valve used to regulate the temperature of flowing water. The device uses an embedded system programmed to control a stepper motor and read inputs from a thermocouple, position sensor, and graphical user interface.

### INTRODUCTION

The purpose of this patent application is to claim ownership over the control system used to operate the mixing valve and the algorithm necessary to run the system effectively. The major components of the system include one stepper motor, one thermocouple, graphical user interface, microcontroller, and mixing valve. The process works by comparing inputs from the user of the system with the readings from the thermocouple. The mixing valve is adjusted accordingly.

### BACKGROUND INFORMATION

The present invention pertains to the control of water temperature through the use of a mixing valve, stepper motor, thermocouple, embedded system, and graphical user interface (GUI). Devices such as this would prove very useful for those who do not have the strength to operate residential plumbing faucets. Other uses include industrial applications where temperature controls are necessary for certain processes. Commercial plumbing apparatus also require some level of temperature control.

### BRIEF SUMMARY OF THE INVENTION

The mixing valve control system will add a level of simplicity to human hygiene. Many disabled people currently have nurses and helpers to aid in bathing due to their frailty or inability to operate the residential plumbing fixtures. The device proposed here would allow the user to define his or her own preferences and would also allow the user to turn the fixture on and off with the push of a button.

Not only can the device be used for the feeble but there are applications for the deaf or blind individual. Voice recognition software could be added to the device to allow the user the ability to communicate his or her demands.

### BRIEF DESCRIPTION OF DRAWINGS

FIG. 1: This figure shows the embedded system that will be used to control the mixing valve. All electrical signals will be processed by the microcontroller.

FIG. 2: This figure shows the mechanical components of the system and how they interact with the electrical system. The goal of this system is to deliver water to the user at their desired temperature.

FIG. 3: The calibration curve is shown in this figure. The calibration curve is an illustration of how the initial mixing valve position is determined.

FIG. 4: This figure shows the algorithm necessary to calibrate the system.

FIG. 5: This is the equation necessary to calculate the initial mixing valve position.

FIG. 6: This figure illustrates the method by which the calibration curve is used to determine the initial mixing valve position.

FIG. 7: Equation necessary to calculate the difference between the desired temperature, Tuser, and the measured temperature, Tfaucet.

FIG. 8: This figure shows the algorithm necessary to operate the system.

### DETAILED DESCRIPTION OF THE INVENTION

The mixing valve control system is an extension of the residential or commercial faucet in that it allows a user to interact with the system. The user can enter his or her desired temperature and the system responds by adjusting the mixing valve so the desired temperature is reached.

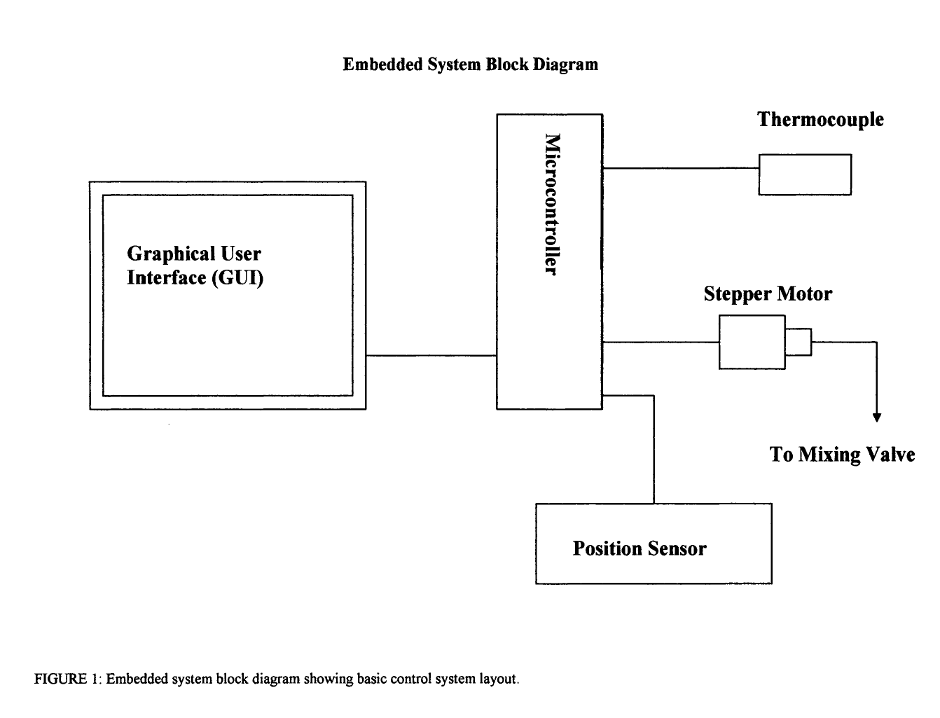

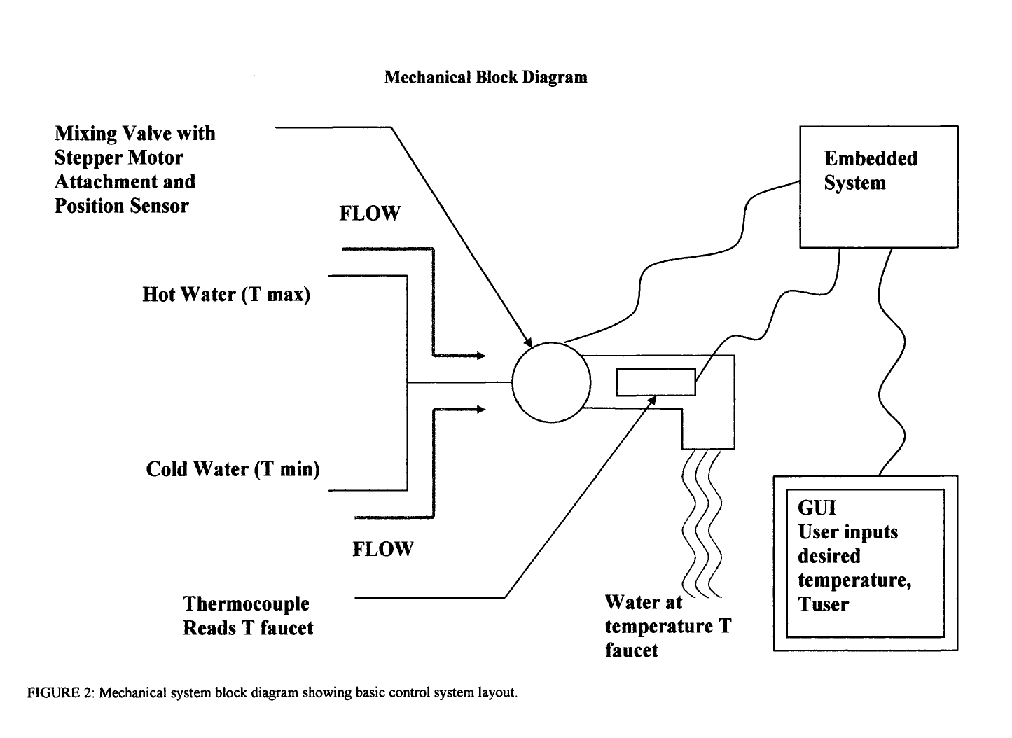

The basic block diagrams for the mechanical electrical systems are shown in FIG. 1 and FIG. 2. The microcontroller is the “brains” of the system. The microcontroller processes the signals going to the stepper motor and coming from the thermocouple, the position sensor, and the graphical user interface. The signals received from the thermocouple, position sensor and graphical user interface are used in the algorithm to compute the position of the mixing valve. Once the mixing valve is in the correct position the desired temperature demanded by the user is reached.

Before the mixing valve control system becomes operational a calibration sequence must be initiated. The calibration cycle allows the system to adjust to the residential settings the user has and also allows for the creation of a calibration curve which will be used during the operation of the device. The following sequence occurs during calibration.

### Calibration Cycle

Before the operation of this device a calibration cycle must occur. The calibration cycle will allow the system to adjust to the user's residential hot water heater settings. The hot water heater will affect the temperature of the water leaving the faucet therefore the system must compensate for this through the calibration cycle.

The first step in the calibration process is for the installer/user to turn the mixing valve clockwise to the coldest position on the faucet knob. The installer/user must then push the calibrate button on the Graphical User Interface (GUI) to begin Part 1 of the calibration cycle. The position sensor will now read the position of the mixing valve. This value will then be stored in the microcontroller as P1. The temperature will also be stored at this point as Tmin.

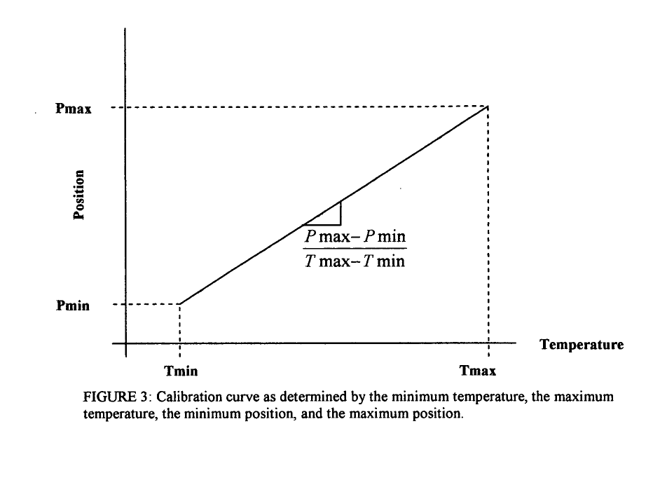

Now that Tmin has been established the user turns the mixing valve counterclockwise until the maximum position is established. The user again presses the calibrate button to begin Part 2 of the calibration cycle. The position sensor as well as the temperature sensor records these values as P2 and Tₘₐₓ respectively. With these values the calibration curve can be established (See FIG. 3).

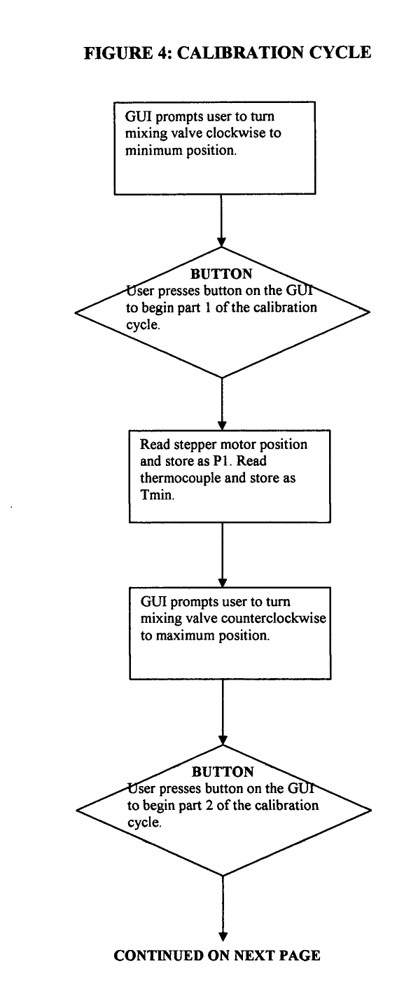

The calibration algorithm gives rise to the calibration curve which can be used during the operation of the faucet. The process diagram shown in FIG. 4 is a visual representation of the calibration algorithm. The basic calibration algorithm does not include the necessary safety cycle to ensure proper operational safety. This would need to be added through vigorous safety testing during product development to ensure that the user does not calibrate this device incorrectly and possibly injure the user.

### Operation Cycle

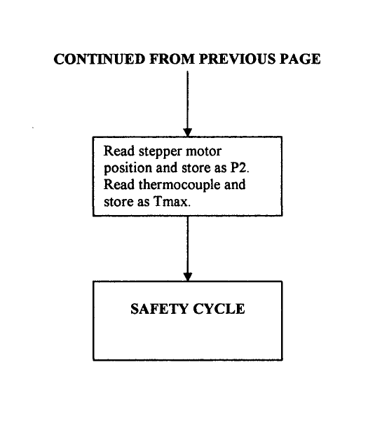

The operation cycle is used to operate the device. Once the device has been calibrated successfully the system is now operational. To initiate the operation cycle the user presses a button on the Graphical User Interface. The button initiates the algorithm. The program has a predetermined set of data gathered during the calibration cycle. The user of the system will input his or her desired temperature which is stored as Tuser. The first set of computations can now be performed. Using the equation shown in FIG. 5 the program determines the position of the stepper motor:

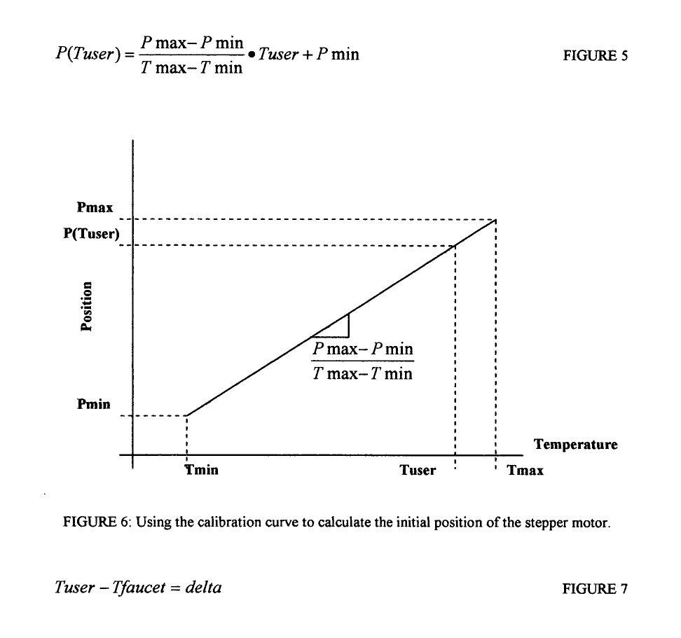

This is the initial position of the mixing valve. This desired valve position is then stored as P. The calibration curve created from calibrating the system will be able to determine the position necessary for the desired temperature. The graph shown in FIG. 6 illustrates this concept.

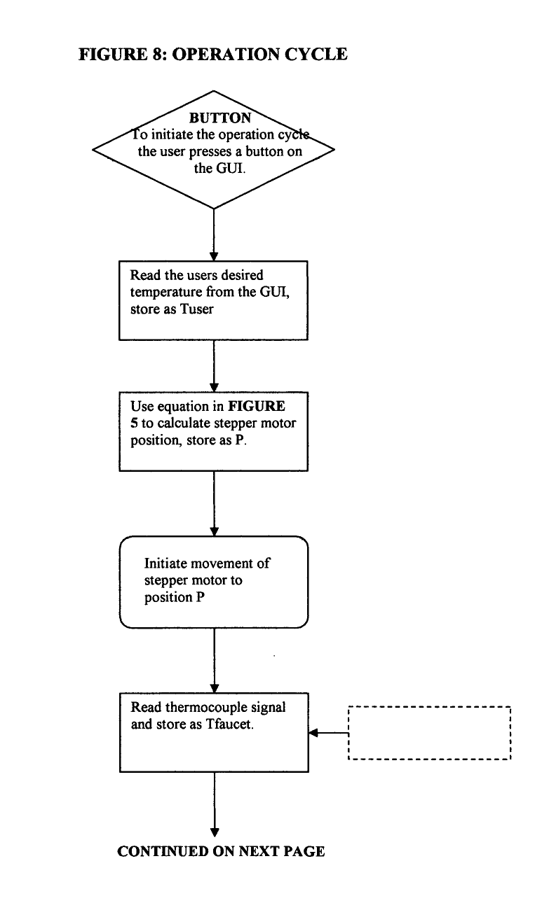

The microcontroller must now read the signal coming from the thermocouple attached to the pipe see FIG. 2. This measurement is now stored as Tfaucet. The microcontroller now calculates the difference between Tuser and Tfaucet and stores the number as delta. FIG. 7 shows the necessary equation to calculate delta.

The program will determine whether delta is positive or negative. If delta is positive the system needs more heat and will signal the stepper motor to rotate counterclockwise. If delta is negative the system needs less heat and will signal the stepper motor to rotate clockwise.

To determine how much the motor must turn to achieve the desired affect the following procedures must occur:

If more heat is needed

The system will determine how large delta is. If delta is greater than 0 the system will add 5% to position P up to Pmax.

The program now measures T faucet again and compares the value to T user. The program will reevaluate these measurements until the user turns the system off.

### If Less Heat is Needed

If the system determines that delta is less than zero the system will decrease position P by 5% up to Pmin. The program will now measure Tfaucet again and compare the value to Tuser. The program will reevaluate these measurements until the user turns the system off.

### If Temperature is Adequate

If the system determines that delta=0 the position P will remain the same. The program will now measure Tfaucet again and compare to Tuser. The program will reevaluate these measurements until the system is turned off.

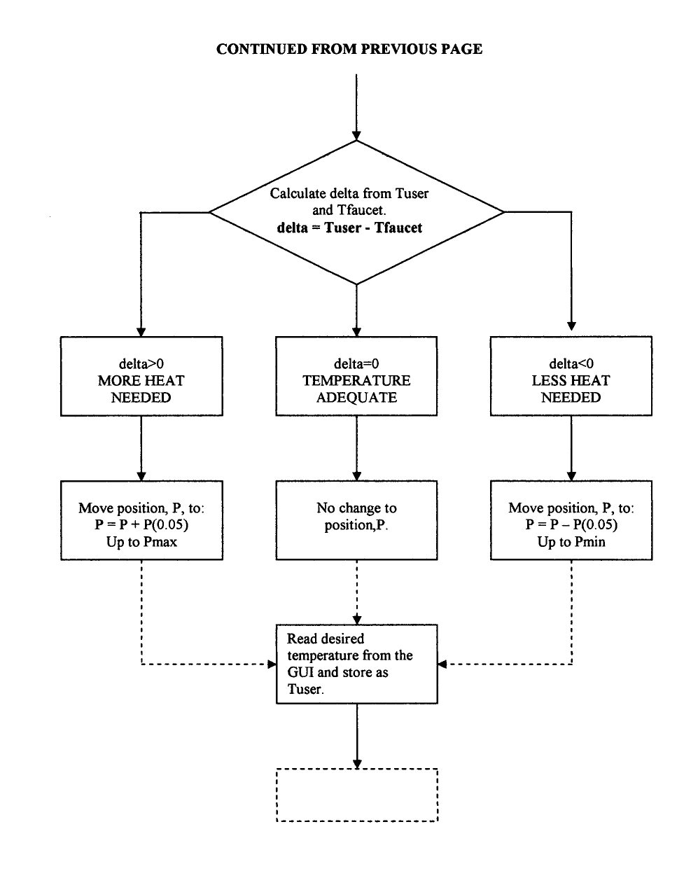

The process diagram shown in FIG. 8 is a visual representation the operation algorithm.

What is claimed is:

1. A process by which to control the temperature of water using a mixing valve and feedback control system.

2. The use of a mixing valve to control the temperature automatically.

3. The uses of a thermocouple, stepper motor, graphical user interface (GUI) and embedded system to control the mixing valve.

4. The algorithms used to control the system set forth by claim 1.
